(19) United States
(12) Patent Application Publication
(10) Pub. No.: US 2005/0064131 A1
(43) Pub. Date: Mar. 24, 2005

(54) Recording medium and recording/reproducing apparatus

(76) Inventors: Atsushi Yamaguchi, Mizuho-city (JP); Hitoshi Noguchi, Gifu-city (JP); Shinji Kobayashi, Ibi-gun (JP); Yoshihisa Suzuki, Ichinomiya-city (JP); Morio Nakatani, Ichinomiya-city (JP); Masahiro Higuchi, Anpachi-gun (JP); Yoshiaki Maeno, Mizuho-Shi (JP)

Correspondence Address: McDERMOTT WILL & EMERY LLP, 600 13th Street, N.W., Washington, DC, 20005-3096, US

(21) Appl. No.: 10/943,240

(22) Filed: Sep. 17, 2004

(30) Foreign Application Priority Data
Sep. 19, 2003 (JP) 2003-328966 (P)

(51) Int. Cl. B32B 3/02

(52) U.S. Cl. 428/64.4

(57) ABSTRACT

The present invention provides smooth and adequate recording/reproducing on a recording medium employing a biodegradable material as a substrate material. The present invention relates to storing on a recording medium, information, structure, or the like indicating that a substrate is formed of a biodegradable material. When the present invention is applied to CD, CD-R, and CD-RW, identification information indicating a substrate formed of a biodegradable material is included in a free area of TOC data in a lead-in area shown in FIG. 4. An optical disc apparatus reads the identification information to identify whether or not a disc loaded into the apparatus has a substrate of a biodegradable material. When the loaded disc has a substrate of a biodegradable material, the optical disc apparatus: measures a temperature inside a drive; stops a recording/reproducing operation on the disc when the temperature approaches a glass transition temperature of a substrate material; and ejects the disc to outside of the apparatus.

### BACKGROUND OF THE INVENTION

1. Field of the Invention

The present invention relates to a recording medium and a recording/reproducing apparatus. The present invention more specifically relates to a recording medium employing a biodegradable material and an apparatus for recording/reproducing on the recording medium.

2. Description of the Related Art

Polycarbonate is generally used as a substrate material of a conventional optical recording medium. Disposal of such used optical recording media causes various problems of pollution in incineration disposal or in landfill disposal of the used optical recording media. Correspondingly, an invention relating to an optical recording medium employing a biodegradable material is disclosed in JP 2000-011448 A, for example. A biodegradable plastic material used as a substrate material of the optical recording medium is already in practical use on a filing date of the present application. Pollution can be suppressed in waste disposal by using a biodegradable plastic material as a substrate material as described in JP 2000-011448 A.

However, a biodegradable plastic material has a lower glass transition temperature than that of polycarbonate, which is a conventional substrate material. Thus, an optical recording medium employing the biodegradable plastic material has a disadvantage of being easily degraded in a high temperature environment. In addition, a biodegradable plastic material has a lower mechanical strength than that of polycarbonate. Thus, an optical recording medium employing the biodegradable plastic material may be damaged when the medium is used under similar conditions as those in a normal use.

### SUMMARY OF THE INVENTION

The present invention is focused on such points, and improves a structure of a recording medium and a structure of a recording/reproducing apparatus for smooth and adequate use of the recording medium employing a biodegradable plastic material as a substrate material. That is, an object of the present invention is therefore to provide: a recording medium which can be used smoothly and adequately while pollution is suppressed in waste disposal to avoid adverse effects on an environment; and a recording/reproducing apparatus for the recording medium.

In order to attain the above object, a structure for identifying that a substrate consists of a biodegradable material is provided on a recording medium. When the structure is detected by a recording/reproducing apparatus, process operations suitable for a recording medium employing a biodegradable material as a substrate material such as stopping a recording/reproducing operation in a high temperature environment are carried out.

A first aspect of the present invention can be grasped as an improvement for a recording medium employing a biodegradable material as a substrate material. According to the first aspect, the recording medium of the present invention stores information indicating that a substrate material is formed of a biodegradable material, for example. The information as used herein is recorded on the recording medium in configurations readable by light such as pits. Alternatively, the recording medium may be provided with an area having a different reflectance to store the information.

Such a constitution of the recording medium with a recording/reproducing apparatus provided with means for reading the information allows detection of whether or not the recording medium loaded into the apparatus employs a biodegradable material as a substrate material. Accordingly, adequate control corresponding to the detection results can avoid problems of: glass transition of a substrate due to exposure to a high temperature environment; and damage in the recording medium by carrying out a recording/reproducing operation to an extent exceeding a mechanical strength of the recording medium.

Further, the recording medium according to the first aspect of the present invention may further stores information indicating the number of times the recording medium is exposed to an environment at a predetermined temperature or more. For example, detection of a temperature inside the apparatus reaching 50° C. or more in use of the recording medium results in recording of information indicating that the number increased by one on the recording medium. In this case, an area for recording the number information must be provided on the recording medium itself or on a cartridge thereof.

Such a constitution of the recording medium with a recording/reproducing apparatus provided with means for reading the number information allows detection of the number of times the recording medium is exposed to a high temperature environment in addition to whether or not the recording medium employs a biodegradable material as a substrate material. And a reliability level of an in-use recording medium can be presented to a user by displaying a warning or the like to a user. Thus, a smoother usage can be provided to a user.

Further, the recording medium according to the first aspect of the present invention may be provided with an area changing in optical characteristics at a predetermined temperature. An optical recording medium to which a laser beam is applied for recording/reproducing may be provided with an area, on a path of the laser beam, consisting of a material changing in light transmittance with increasing temperature. To be more specific, a layer consisting of a material having a light transmittance decreasing with increasing temperature is formed on a light incidence surface or a recording layer side surface of the substrate. An example of such a material that can be used includes vanadium oxide which is excellent in light transmittance at normal temperatures and that has a drastically reduced light transmittance at a temperature approaching a glass transmission temperature of a substrate material.

Such a constitution of the recording medium allows adequate monitoring of temperature increase in a recording/reproducing process because an intensity of a reflected light from the recording layer decreases with increasing substrate temperature. In particular, use of vanadium oxide or the like as a material of the layer drastically changes the reflectance intensity in a temperature range slightly lower than the glass transition temperature. Thus, an operation for preventing breaking of the substrate such as stopping of a recording/reproducing operation or a disc ejecting operation can be carried out promptly corresponding to the temperature of the substrate approaching the glass transition temperature while an adequate recording/reproducing operation is being carried out.

The recording medium according to the first aspect of the present invention may be provided with an area changing in color at a predetermined temperature on a disc. The area may be provided by attaching onto the recording medium, an irreversible temperature detection sticker (thermo label or the like) having a temperature indication portion changing in color at a specific temperature.

Such a constitution of the recording medium allows a user to visually check the reliability of the recording medium.

A second aspect of the present invention can be grasped as an apparatus for recording/reproducing information on a recording medium.

That is, a recording/reproducing apparatus includes: detection means for detecting that a substrate of the recording medium consists of a biodegradable material; temperature measurement means for measuring a temperature inside the recording/reproducing apparatus; and control means for controlling an operation on the recording medium based on detection results of the detection means and measurement results of the measurement means.

According to the second aspect of the present invention, the control means controls to stop a recording/reproducing operation on a loaded recording medium. The term “to stop” may be construed to include “to suspend” (interruption).

Such a constitution of the apparatus can avoid a recording/reproducing operation at a temperature approaching a glass transition temperature of a biodegradable material constituting a substrate. Thus, deformation or the like of the substrate due to exposure to a high temperature environment can be prevented.

Further, according to the second aspect of the present invention, the recording medium may be ejected to outside of the apparatus based on the detection results of the detection means and the measurement results of the measurement means. Thus, exposure of the recording medium to a high temperature environment can be avoided, and a problem of deformation or the like of the substrate can be avoided more precisely.

Further, according to the second aspect of the present invention, the recording/reproducing apparatus may include: detection means for detecting that a substrate of the recording medium consists of a biodegradable material; and control means for controlling a loading operation of the recording medium. The control means ejects the recording medium to outside of the recording/reproducing apparatus corresponding to detection by the detection means that the substrate of the recording medium consists of a biodegradable material. Thus, a recording medium is ejected to outside of the recording/reproducing apparatus immediately after the loading of the recording medium. Thus, loading of the recording material employing a biodegradable material as a substrate of the recording material on the recording/reproducing apparatus which is already at high temperatures such as an on-vehicle recording/reproducing apparatus can be promptly avoided.

Further, according to the second aspect of the present invention, the recording/reproducing apparatus includes: detection means for detecting that a substrate of the recording medium consists of a biodegradable material; and control means for controlling a rotational speed of the recording medium. The control means sets a maximum rotational speed of the recording medium to a lower value than the maximum rotational speed of the recording medium having a substrate consisting of nonbiodegradable material when the detection means detects that the substrate of the recording means consists of a biodegradable.

Such a constitution of the apparatus avoids deformation or damage in a substrate due to a centrifugal force or surface vibration in high-speed rotation.

As described above in the first and second aspects of the present invention, the reliability of the recording medium can be secured and usage durability of the recording medium and the apparatus into which the recording medium is loaded can be enhanced while a smooth recording/reproducing operation is being carried out.

### BRIEF DESCRIPTION OF THE DRAWINGS

The above-mentioned object, other objects, and novel characteristics of the present invention shall be completely clarified by referring to the descriptions of an embodiment mode with reference to the accompanying drawings:

FIG. 1 shows a diagram of an optical disc structure according to an embodiment mode of the present invention;

FIG. 2 shows a diagram of an optical disc structure according to an embodiment mode of the present invention;

FIGS. 3A and 3B each show a diagram of a part of an optical disc structure according to an embodiment mode of the present invention;

FIG. 4 shows a diagram of an area format of an optical disc according to an embodiment mode of the present invention;

FIG. 5 shows a diagram of a structure of an optical disc apparatus according to an embodiment mode of the present invention;

FIG. 6 shows a diagram of a circuit configuration of an optical disc apparatus according to an embodiment mode of the present invention;

FIG. 7 shows an operation flowchart of an optical disc apparatus according to Embodiment 1;

FIG. 8 shows a modified example of an operational flow of the optical disc apparatus according to Embodiment 1;

FIG. 9 shows another modified example of the operational flow of the optical disc apparatus according to Embodiment 1;

FIG. 10A shows an operation flowchart of an optical disc apparatus according to Embodiment 2;

FIG. 10B shows an operation flowchart of an optical disc apparatus according to Embodiment 3;

FIG. 11 shows an area format of an optical disc according to Embodiment 4;

FIG. 12 shows an operation flowchart of the optical disc apparatus according to Embodiment 4;

FIG. 13 shows an optical disc structure according to Embodiment 5;

FIG. 14 shows an operation flowchart of the optical disc apparatus according to claim 5;

FIGS. 15A and 15B each show structures of an optical disc and an optical disc apparatus according to Embodiment 6;

FIGS. 16A and 16B each show a modified example of the structures of the optical disc and the optical disc apparatus according to Embodiment 6;

FIG. 17 shows an operation flowchart of the optical disc apparatus according to Embodiment 6;

FIGS. 18A and 18B each show an optical disc structure according to Embodiment 7; and

FIG. 19A shows an optical disc structure according to Embodiment 9.

### DETAILED DESCRIPTION OF THE PREFERRED EMBODIMENTS

Hereinafter, an embodiment mode of the present invention will be described with reference to the drawings. However, the following embodiment mode is a mere example of the present invention and does not limit the scope of the present invention.

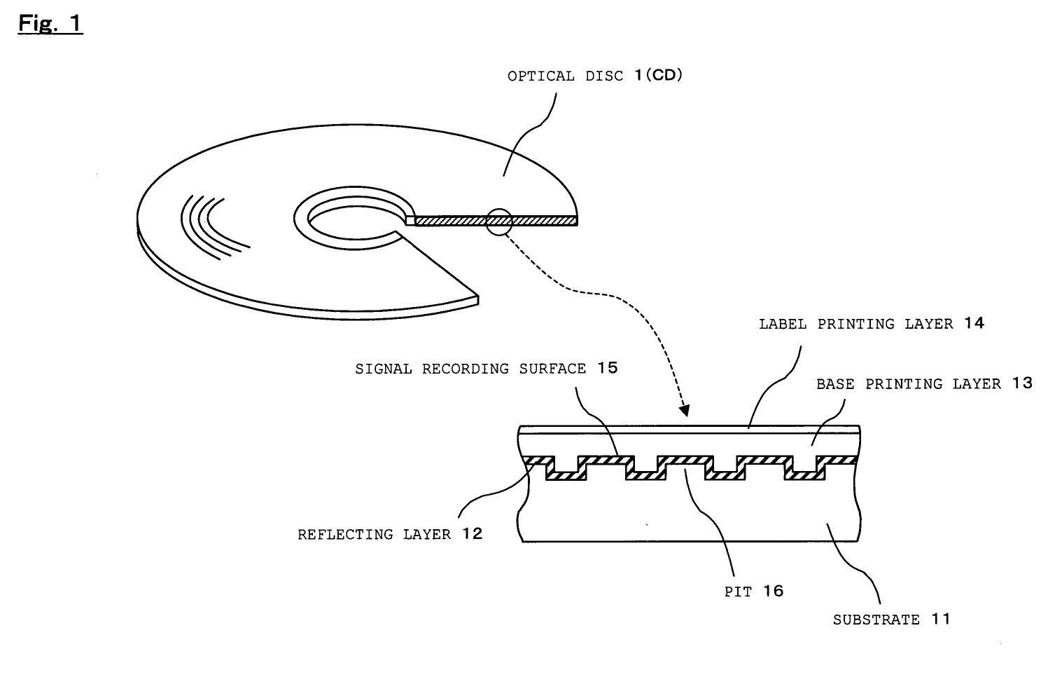

FIG. 1 shows a structure of an optical disc according to an embodiment mode of the present invention. In the embodiment mode of the present invention, a read-only compact disc (CD) or a recordable/rewritable compact disc (CD-R: CD-Recordable, CD-RW: CD-ReWritable) are used as an optical disc. However, the present invention is not limited to those discs and may be applied to other recording media such as a DVD (Digital Versatile Disc).

FIG. 1 shows a disc structure of a disc 1 as a CD. The disc 1 has a laminate structure of a substrate 11, a reflecting layer 12, a base printing layer 13, and a label printing layer 14.

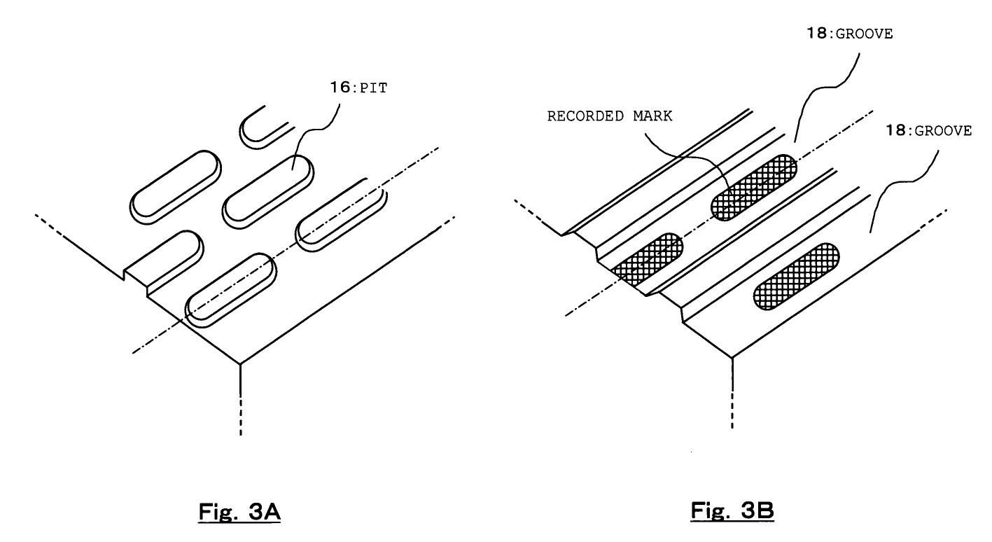

The substrate 11 has a signal recording surface 15 on one side thereof. As shown in FIG. 3A, pits 16 changing in length and spacing corresponding to recorded information are formed spirally on the signal recording surface 15.

The substrate 11 consists of a transparent biodegradable plastic material which is degraded by an aerobic microbe. A typical transparent biodegradable plastic includes a plastic formed from polylactic acid as a main raw material. Examples of such a material include: “LACTY” (a tradename of Toyota Motor Corporation); “LACEA” (a tradename of Mitsui Chemicals, Inc.); and “TERRAMAC” (a tradename of Unitika Ltd.).

In FIG. 1, the reflecting layer 12 is laminated on the signal recording surface 15 of the substrate 11. The reflecting layer 12 is formed of a material degraded in the natural world (such as a material degraded by oxygen, water, or the like) or a material present in the natural world such as deposited minerals. The reflecting layer 12 consists of a single layer film or multilayer film of aluminum, gold, and silver. The reflecting layer 12 employing an aluminum single layer film has a thickness of 40 nm.

The base printing layer 13 is formed directly on the reflecting layer 12 and covers at least an area of the signal recording surface 12 on which signals are recorded. The label printing layer 14 is laminated on the base printing layer 13. The base printing layer 13 and the label printing layer 14 each consist of a material degraded in the natural world such as a biodegradable plastic, soybean oil, and starch, a material degraded in the natural world or a material present in the natural world. Examples of such a material include: “BIOTECH COLOR” (a tradename of Dainichiseika Color & Chemicals Mfg. Co., Ltd.); and “NEXT GP” (a tradename of TOYO INK MFG. CO., LTD.). The base printing layer 13 and the label printing layer 14 have a thickness of 4 to 6 μm and 6 to 9 μm, respectively.

Production of the optical disc 1 involves the following process. First, the substrate 11 having the pit 16 transferred on one side thereof is formed through injection molding of the above-mentioned biodegradable plastic. Then, the reflecting layer 12 is formed on the signal recording surface 15 through vacuum deposition, sputtering, or the like. Further, the base printing layer 13 and the label printing layer 14 are sequentially formed on the reflecting layer 12 through silk-screen printing or the like.

Iron may be used as a material for the reflecting layer 12. A disc employing iron as a material for the reflecting layer 12 according to the embodiment mode of the present invention may be distinguished from a normal CD by using a magnetometric sensor or the like. Thus, the CD employing a biodegradable material according to the embodiment mode of the present invention may be sorted out from the normal CD for fractional recovery. However, reflectance of iron is lower than reflectance of aluminum used as a reflecting layer material in the normal CD, thereby requiring a structure for enhancing the reflectance. The reflectance may be enhanced by, for example: forming an iron thin film on the signal recording surface 15; and forming a multilayer film containing a silicon oxide thin film and a silicon thin film laminated. A reflectance sufficient for reproduction can be obtained with, for example: an iron thin film having a thickness of 150 nm; a silicon oxide thin film having a thickness of 100 nm; and a silicon thin film having a thickness of 45 nm.

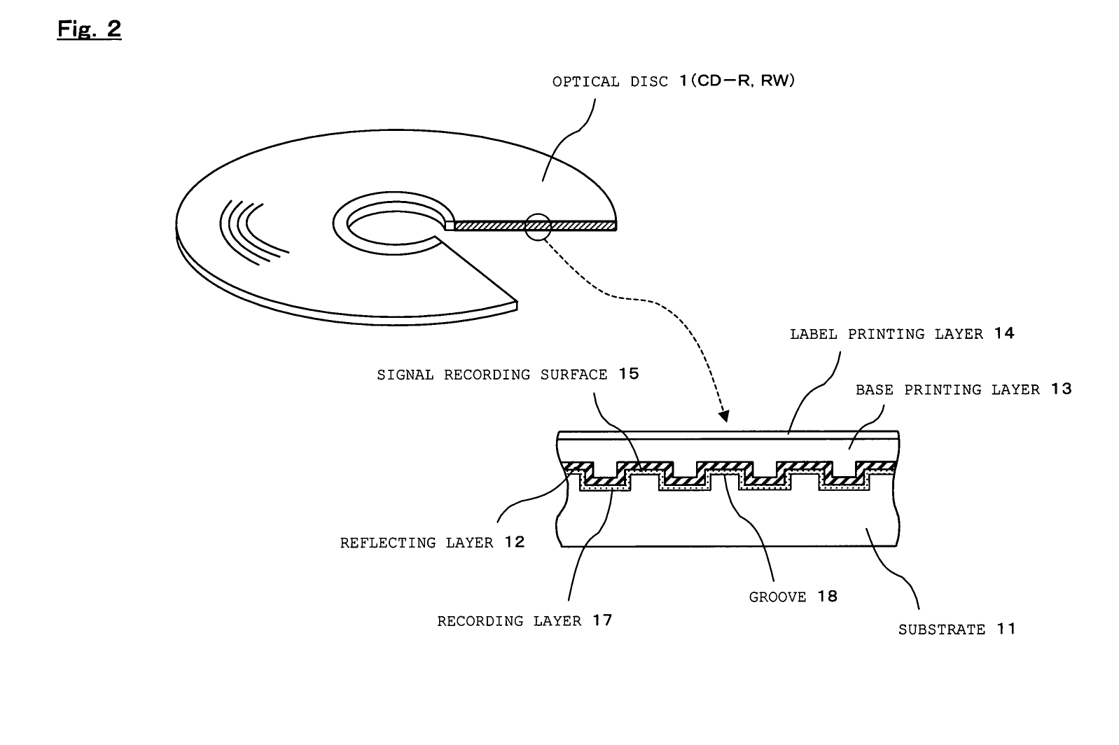

FIG. 2 shows a disc structure of the disc 1 as a CD-R/RW. As shown in FIG. 2, the disc 1 has a laminate structure of the substrate 11, the reflecting layer 12, the base printing layer 13, and the label printing layer 14. The CD-R/RW has a recording layer 17 is added to the structure of the CD.

As shown in FIG. 3B, a groove 18 constituting a recording track is formed spirally on the signal recording surface 15. The groove 18 wobbles in a radial direction of the disc. The wobble generates a synchronizing clock during recording/reproducing. Further, a wobble waveform in a lead-in area stores ATIP information including varied control information as described below.

A production process of the disc 1 shown in FIG. 2 includes the step of forming the recording layer 17 in addition to the production process of the CD. That is, the substrate 11 having the groove 18 (data area) transferred on one side thereof is formed through injection molding of the above-mentioned biodegradable plastic. Then, the recording layer 17 and the reflecting layer 12 are sequentially formed on the signal recording surface 15 through vacuum deposition, sputtering, or the like. Further, the base printing layer 13 and the label printing layer 14 are sequentially formed on the reflecting layer 12 through silk-screen printing or the like.

The disc 1 as a CD-R employs an organic coloring matter as a material for the recording layer 17. The disc 1 as a CD-RW employs a phase change material as a material for the recording layer 15. Examples of the phase change material include an alloy containing Ag, In, Sb, Te, or the like as main components. A layer structure of a magnetooptic disc includes a dielectric layer in addition to the layer structure shown in FIG. 2 and has a different material for the recording layer 17. The magnetooptic disc employs a magnetic material such as TbFeCo, GdFeCo, or the like as a material for the recording layer 17.

As described above, the optical disc 1 employing a material degraded by the natural world or a material present in the natural world does not generate a toxic gas through incineration in waste disposal of the optical disc. Further, the optical disc degrades spontaneously in landfill disposal and does not cause soil contamination or the like, thereby reducing environmental loads.

In the descriptions below, the optical disc 1 (CD, CD-R/RW) formed of the above-mentioned material according to the embodiment mode of the present invention will be referred to as a “biodegradable disc”, and a normal CD, CD-R/RW will be referred to as a “normal disc”.

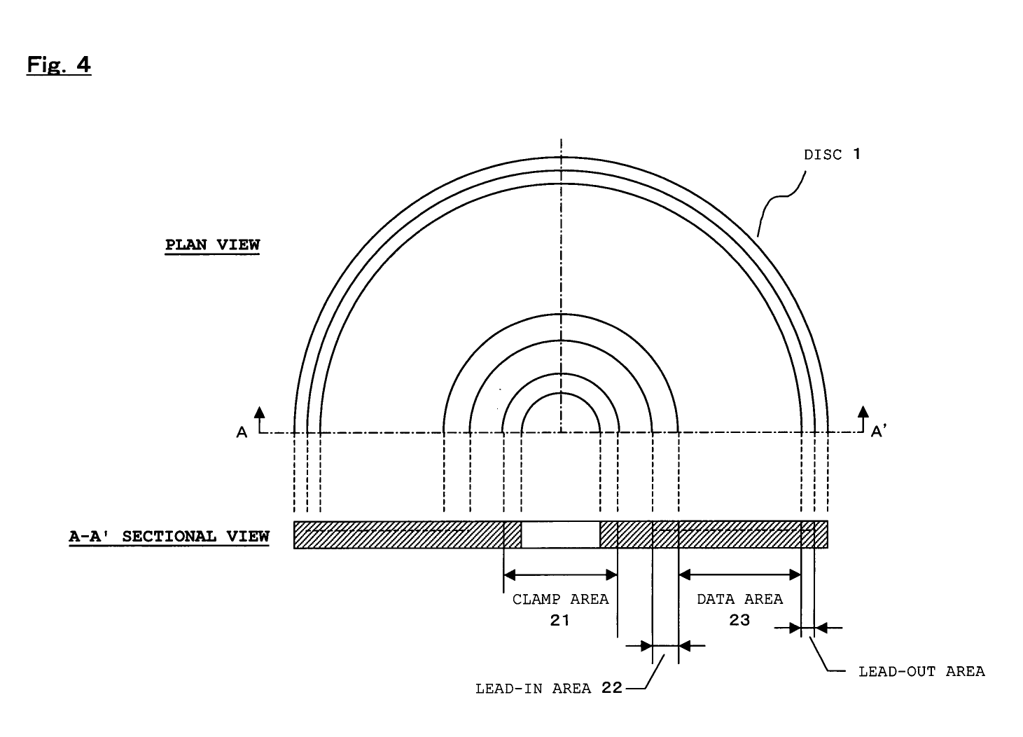

FIG. 4 shows an area format of a CD (normal disc). As shown in FIG. 4, a disc 1 is divided into a clamp area 21, a lead-in area 22, a data area 23, and a lead-out area 24, sequentially from an inner diameter. In the lead-in area 22, subcode information including TOC (Table of Contents) is recorded in a pit. In the data area 23, program information such as music is recorded in the pit.

An area format of CD-R or CD-RW (normal disc) is the same as the area format of the CD shown in FIG. 4 except that the groove 18, instead of the pit, is formed in the lead-in area 22, the data area 23, and the lead-out area 24. In the lead-in area 22 of the CD-R/RW, TOC (Table of Contents) is recorded after a user data is recorded on the data area 23. Further, a wobble waveform of the groove 18 in the lead-in area stores ATIP information including varied control information. Further, the CD-R/RW is provided with PCA (Power Calibration Area) and PMA (Power Memory Area) on an inner diameter side of the lead-in area 22, in addition to the area format shown in FIG. 4. The groove 18 is formed on the PCA and the PMA as well.

A similar area format is employed in the biodegradable disc according to the embodiment mode of the present invention. That is, the area format shown in FIG. 4 is employed in a CD-type biodegradable disc. The same area format is employed in a CD-R/RW-type biodegradable disc as the format of the above-mentioned CD-R/RW (normal disc).

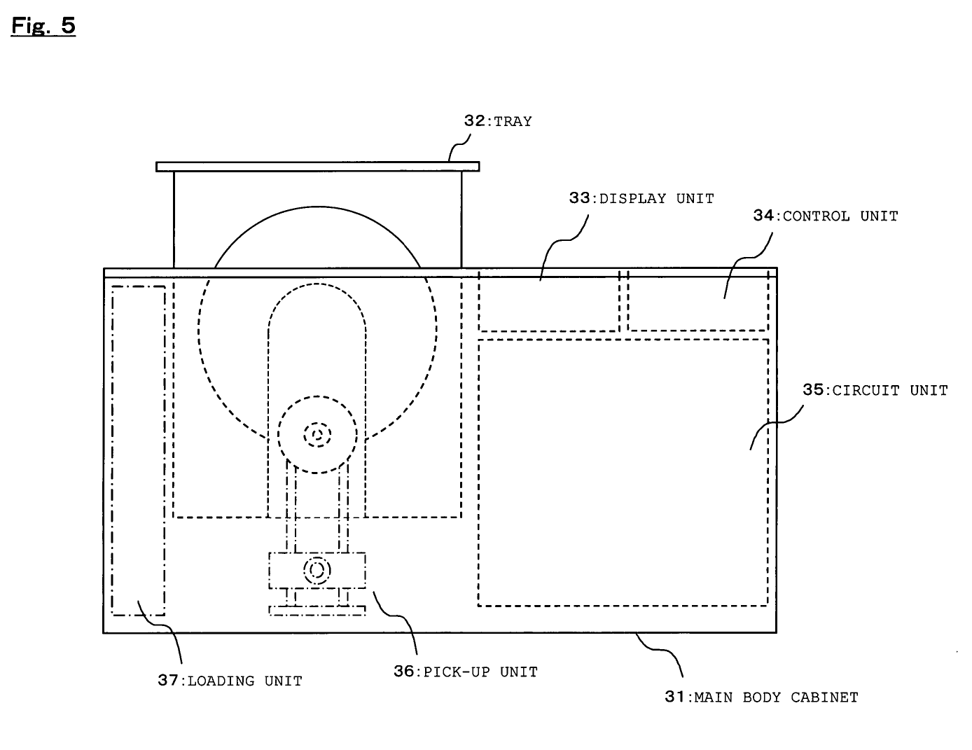

FIG. 5 shows a structure of an optical disc apparatus according to the embodiment mode of the present invention.

A tray 32 for carrying in and carrying out a disc is provided on a front side of a main body cabinet 31 of the optical disc apparatus. Further, the front side of the main body cabinet 31 is provided with: a display unit 33 to display mode information or lapse time period during recording/reproducing; and a control unit 34 to input operation command. Inside of the main body cabinet 31 is provided with: a circuit unit 35; a pick-up unit 36 for recording/reproducing; and a loading unit 37 for driving the tray 32.

FIG. 5 shows an optical disc apparatus of a tray loading-type in which a disc is carried into and out of the apparatus by the tray 32. However, an optical disc apparatus of a slot loading-type, in which a disc is carried into and out of the apparatus through a slot provided on a front side of a panel, is provided with a feed mechanism such as a pressure roll for carrying the disc into and out of the apparatus through the slot, instead of the tray 32. Note that a circuit configuration or process operations described below may be applied to any type of an optical disc apparatus unless otherwise noted particularly.

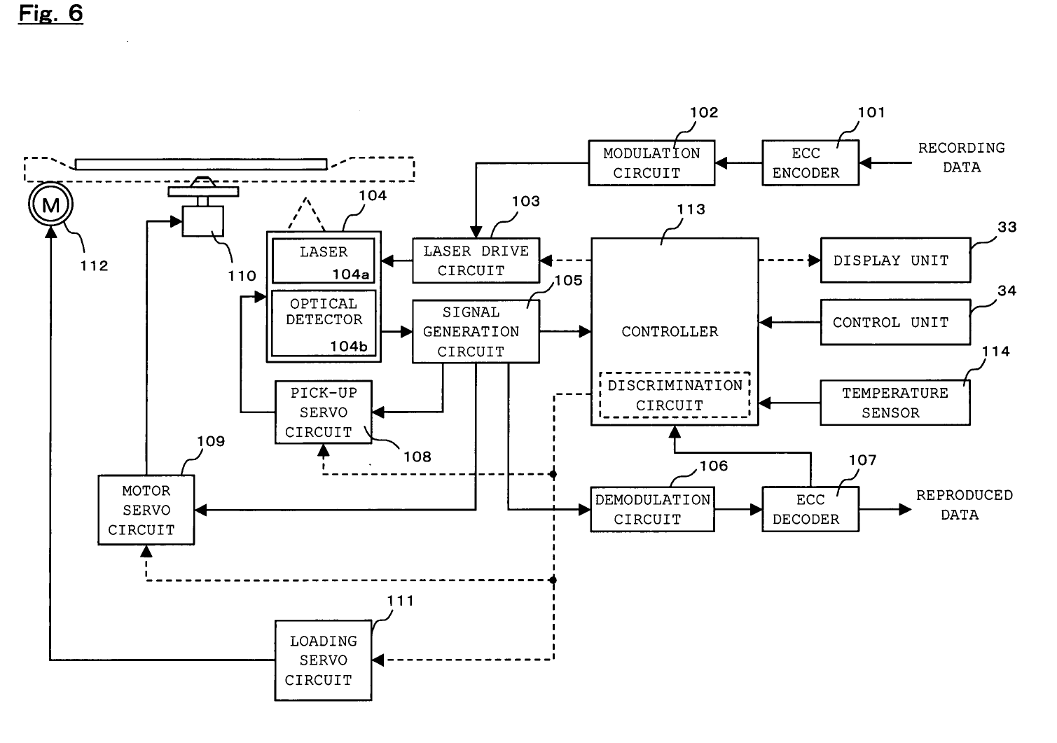

FIG. 6 shows a circuit configuration of an optical disc according to the embodiment mode of the present invention. The configuration allows recording/reproducing on both the biodegradable disc according to the embodiment mode of the present invention and the normal CD or CD-R/RW.

As shown in FIG. 6, the optical disc apparatus is provided with: an ECC encoder 101; a modulation circuit 102; a laser drive circuit 103; an optical pick-up 104; a reproduced signal generation circuit 105; a demodulation circuit 106; an ECC decoder 107; a pick-up servo circuit 108; a motor servo circuit 109; a spindle motor 110; a loading servo circuit 111; a loading motor 112; a controller 113; a temperature sensor 114.

The ECC encoder 101 executes proccessings such as addition of error-correcting code on input recorded data and outputs the processed data to the modulation circuit 102. The modulation circuit 102 executes processings such as eight-to-fourteen modulation on the input recorded data to generate and output recorded signals to the laser drive circuit 103. The laser drive circuit 103 outputs drive signals corresponding to the recorded signals from the modulation circuit 102 to a semiconductor laser 104a during recording, and outputs the drive signals for emitting a laser beam at a given intensity to the semiconductor laser 104a during reproducing.

The optical pick-up 104 is provided with the semiconductor laser 104a and an optical detector 104b. In addition, the optical pick-up 104 is provided with: an objective lens actuator for adjusting a state of laser beam emission to a track consisting of a series of pits or grooves; and an optical system for guiding the laser beam emitted from the semiconductor laser 104a to the objective lens and guiding a reflected light from the disc 1 to the optical detector 104b.

The signal generation circuit 105 generates various signals from signals received from the optical detector 104b through amplification and processes and outputs the signals to the corresponding circuits. The demodulation circuit 106 demodulates reproduced RF signals input from the signal generation circuit 105, and generates and outputs reproduced data to the ECC decoder 107. The ECC decoder 107 corrects error on the reproduced data input from the modulation circuit 106 and outputs the error corrected data to latter circuits.

The pick-up servo circuit 108 generates focus servo signals and tracking servo signals from focus error signals and tracking error signals input from the signal generation circuit 105 and outputs these signals to the objective lens actuator of the optical pick-up 104. The motor servo circuits 109 generates motor servo signals from synchronizing signals or wobble signals input from the signal generation circuit 105 and outputs to the spindle motor 110.

The loading servo circuit 111 drives the loading motor 112 carrying the disc 1 into and out of the apparatus to a carry-in direction or a carry-out direction in response to an instruction from the controller 113. The loading motor 112 is included in a loading unit 37, which drives the tray 32, when the optical disc apparatus is of a tray loading-type as shown in FIG. 1.

The controller 113 stores various data in internal memory and controls each portion of the apparatus following a program set in advance. The temperature sensor 114 detects a temperature inside the optical disc apparatus and outputs detection results to the controller 113.

The controller 113 is provided with a discrimination circuit for discriminating whether a disc loaded into the optical disc apparatus is a normal disc or a biodegradable disc and executes processings in recording/reproducing based on the discrimination results. The biodegradable disc stores information that the disc itself is a biodegradable disc. The controller 113 acquires the information based on the reproduced data from the ECC decoder 107 or the reproduced signals from the reproduced signal generation circuit 105. The controller 113 determines whether the loaded disc is a normal disc or a biodegradable disc in the discrimination circuit based on the information.

The controller 113 displays a state of recording/reproducing on the loaded optical disc, a temperature inside the optical disc apparatus, a warning based on the temperature, or the like on the display unit 33. For example, the controller 113 displays on the display unit 33 that the loaded disc is a biodegradable disc, a temperature inside the optical disc apparatus is at a predetermined temperature or more, or the like.

### Embodiment 1

Varied control information is recorded on the lead-in area in the area format shown in FIG. 4. For example, a CD includes information recorded as subcode information such as track information (number of songs, fragmentation) and disc name information (disc name, song title). Further, a CD-R/RW includes ATIP information containing a laser power value required for recording, an address of a data-recordable area, or the like recorded in the wobble of the groove 18.

In Embodiment 1, an optical disc as a biodegradable disc stores identification information indicating a biodegradable disc in a part of the lead-in area. To be specific, a CD-type biodegradable disc includes the identification information on a data-free area of subcode information. A CD-R/RW-type biodegradable disc includes the identification information on a data-free area of ATIP information, that is, on a disc application code, for example. An area for recording the identification information may be set separately from the lead-in area, for recording the identification information as data.

In the descriptions below, an area on which the identification information indicating a biodegradable disc is recorded will be referred to as a “management area”.

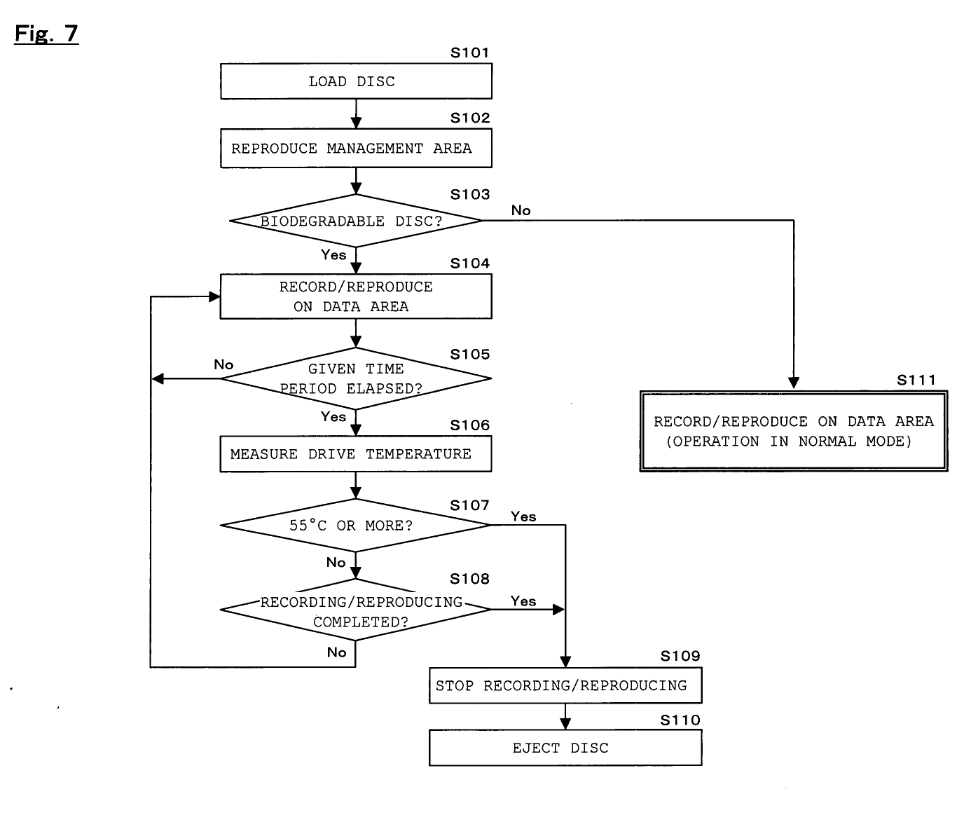

FIG. 7 shows an operational flow of an optical disc apparatus in Embodiment 1.

The disc 1 is loaded into the optical disc apparatus (step S101), and a management area is read by the optical pick-up 104 (step S102). In subsequent step S103, the controller 113 determines whether or not the identification information indicating a biodegradable disc is recorded on the management area. When the identification information is recorded, the controller 113 judges that the loaded disc is a biodegradable disc and the process proceeds to step S104. In this case, the controller 113 measures (step S106) a temperature inside the optical disc apparatus based on an output from the temperature sensor 114 during recording/reproducing on the data area 23 after every lapse of a given time period (step S105). Then, when the measured temperature reaches a predetermined temperature or more (55° C. or more, for example) (step S107: Yes), recording/reproducing on the disc is stopped (step S109). Further, the loading motor 112 is driven to eject the disc from the optical disc apparatus (step S110).

When the controller 113 judges that the identification information indicating a biodegradable disc is not recorded on the management area in step S103, the process proceeds to step S111. In this case, the controller 113 executes a recording/reproducing processing on a normal disc without periodically measuring the temperature inside the apparatus during recording/reproducing (step S111).

Further, when the controller 113 judges that the temperature inside the apparatus is not at a predetermined temperature (55° C., for example) or more in step S107, the controller 113 determines whether or not a recording/reproducing operation is completed (step S108). If the recording/reproducing operation is not completed, the process returns to step S104 for the processings thereafter. If the recording/reproducing operation is completed, the process proceeds to step S109 for stopping of the recording/reproducing processing and for ejecting of the disc.

When the controller 113 judges that the loaded disc 1 is a biodegradable disc in step S103, the controller 113 may display that the loaded disc 1 is a biodegradable disc on the display unit 33 before or during the recording/reproducing operation. Thus, a user can easily identify that the loaded disc 1 is a biodegradable disc, and can decide whether or not a recording/reproducing processing is necessary thereafter.

As mentioned above, the optical disc is ejected when a temperature inside the optical disc apparatus is 55° C. or more in step 107, but the temperature is a mere example and may be set to another threshold temperature. A glass transition temperature of a biodegradable plastic is about 60° C., and thus, the biodegradable disc is preferably not used in the optical disc apparatus reaching an inside temperature of 60° C. Thus, as mentioned above, the threshold temperature is set to 55° C., which is 5° C. lower than a glass transition temperature of the biodegradable plastic at 60° C. Recording/reproducing on the biodegradable disc is stopped when the temperature reaches the threshold temperature or more.

In a flowchart shown in FIG. 7, a temperature inside the optical disc apparatus is not measured immediately after the controller 113 judges that the loaded optical disc 1 is a biodegradable disc in step S103. First, recording/reproducing is carried out on the data area in step S104. After a lapse of a given time is detected in step S105, a temperature inside the apparatus is measured in step S106. Such a flow is a result of consideration that a temperature inside an optical disc apparatus used in households increases when the apparatus is used for a long period of time, for example.

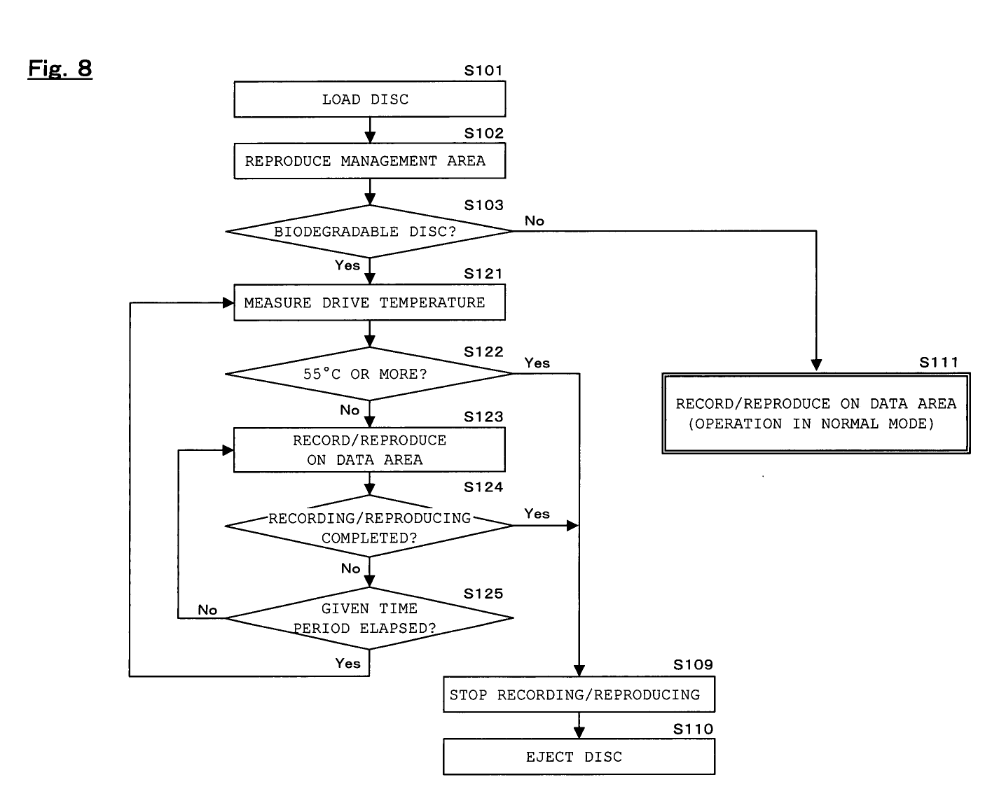

As shown in FIG. 8, a temperature inside the optical disc apparatus may be measured in step S121 immediately after the controller 113 judges that the loaded disc 1 is a biodegradable disc in step S103, instead of a flowchart shown in FIG. 7. In this case, processings in steps S104 to S108 of a process flow in FIG. 7 are changed to processings in steps S121 to S125.

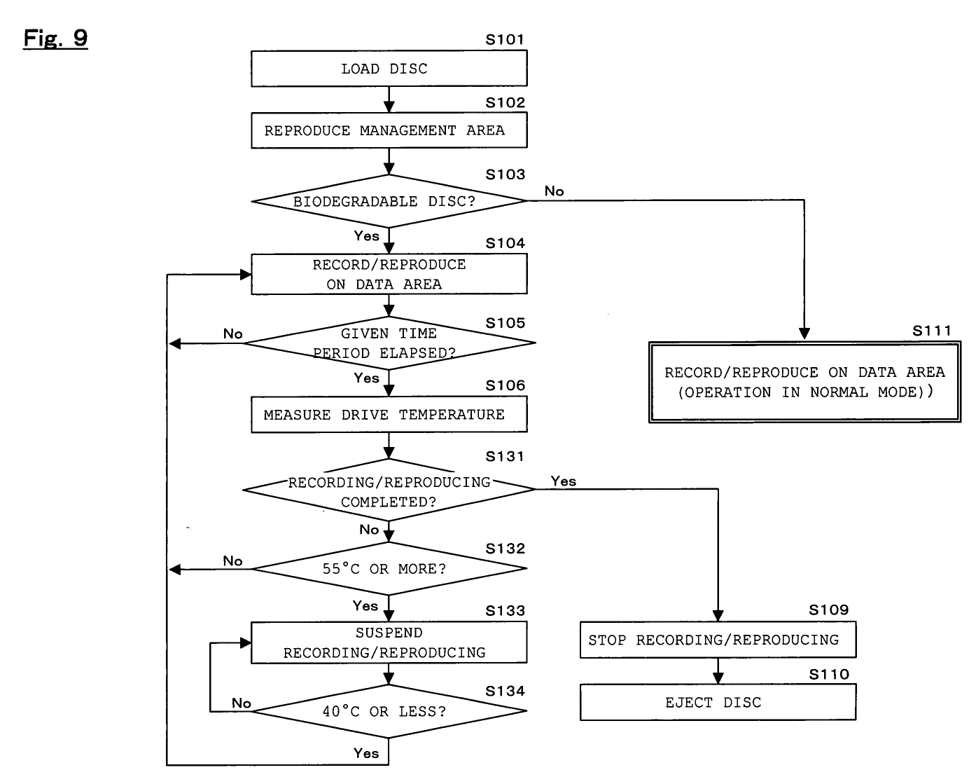

Unlike the flowchart in FIGS. 7 or 8 in which the optical disc 1 is ejected immediately after the temperature inside the optical disc apparatus reaches a threshold temperature or more, as shown in FIG. 9, a recording/reproducing operation on the data area may be stopped (step S133) corresponding to the fact that a temperature inside the optical disc apparatus had reached a threshold temperature or more (step S132: Yes) to wait until the temperature inside the optical disc reaches a predetermined temperature (40° C., for example) or less (step S134). In this case for example, processings in steps S107 and S108 of the process flow in FIG. 7 are changed to processings in steps S131 to S134.

Suspending of the recording/reproducing operation in step S133 involves: stopping of a rotational drive of the spindle motor 110; and turning OFF of the various circuits inside the optical disc apparatus and the semiconductor laser 104a installed in the optical pick-up 104. Thus, the temperature inside the apparatus is reduced and when the temperature inside the apparatus reaches a predetermined temperature (40° C., for example) or less, the operation of the optical disc apparatus is restarted.

At this time, the rotational drive of the spindle motor 110 may not be stopped, considering that heat dissipation or cooling of the optical disc 1 can be accelerated by airflow generated by rotation of the optical disc 1.

The identification information indicating a biodegradable disc may be stored on a disc by providing an area having a different reflectance from those of other areas in a predetermined area on the disc, in addition to or instead of recording the identification information on a part of the management area as data. In this case, a laminate thin film of SiOx, SiNx, AlOx, TiOx, or the like is formed in a specific area on the substrate, to provide an area having a different reflectance from those of other areas. The specific area need not be provided in the management area.

### Embodiment 2

A biodegradable plastic substrate is inferior in strength to a polycarbonate substrate of a normal CD. In Embodiment 2, whether or not the loaded optical disc 1 is a biodegradable disc is determined, and if the optical disc 1 is a biodegradable disc, a disc rotational speed is restricted to be lower than that of the normal disc. To be specific, a maximum disc rotational speed set in multi-speed recording/reproducing is not applied to the biodegradable disc, or a maximum disc rotational speed is set to a lower value than that of the normal disc. Thus, a disc damage by high-speed rotation can be avoided.

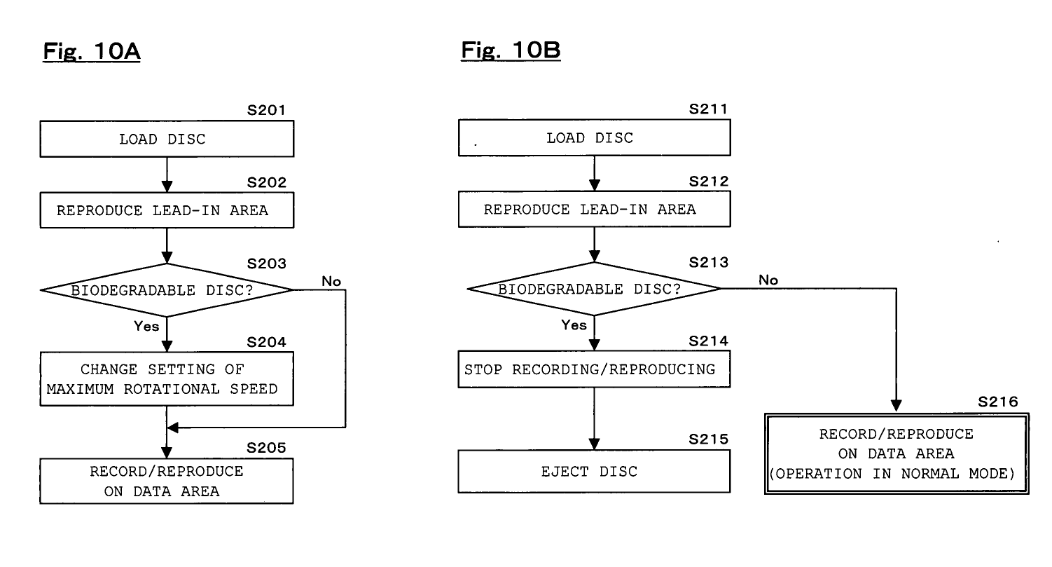

FIG. 10A shows a process flow in Embodiment 2. The disc format is the same as that in Embodiment 1 (FIG. 4). The identification information indicating a biodegradable disc is recorded in a part of the management area.

The disc 1 is loaded into the optical disc apparatus (step S201), and the management area is read by the optical pick-up 104 (step S202). In subsequent step S203, the controller 113 determines whether or not the identification information indicating a biodegradable disc is recorded on the management area (step S203). When the identification information is recorded, the controller 113 judges that the loaded disc is a biodegradable disc and the process proceeds to step S204 for changing the maximum rotational speed. To be specific, a value of the maximum rotational speed stored in the internal memory of the controller 113 is replaced with that of the biodegradable disc in step S204. Then, recording/reproducing is carried out on the data area (step S205). When the controller 113 judges that the loaded optical disc is not a biodegradable disc, the maximum rotational speed is not changed.

### Embodiment 3

In Embodiment 3, whether or not the optical disc is a biodegradable disc is checked immediately after the optical disc is loaded into the optical disc apparatus based on the identification information recorded on the optical disc, and if the optical disc is a biodegradable disc, use of the biodegradable disc is not accepted.

FIG. 10B shows a process flow in Embodiment 3. The disc format is the same as that in Embodiment 1 (FIG. 4). The identification information indicating a biodegradable disc is recorded in a part of the management area.

The disc 1 is loaded into the optical disc apparatus (step S211), and the management area 21 is read by the optical pick-up 104 (step S212). In subsequent step S213, the controller 113 determines whether or not the identification information indicating a biodegradable disc is recorded on the management area (step S213). When the identification information is recorded, the controller 113 judges that the loaded disc is a biodegradable disc and recording/reproducing on the optical disc is stopped (step S214) and the disc is ejected from the optical disc apparatus (step S215). That is, when the loaded optical disc is a biodegradable disc, the optical disc apparatus does not accept the use of the disc. A disc determined in step S213 as having no identification information recorded on the management area is judged as a normal disc, not a biodegradable disc, and the recording/reproducing operation is carried out on the data area (step S216).

The optical disc apparatus in Embodiment 3 is useful for an optical disc apparatus used in an automobile. The inside of the automobile often reaches high temperatures under the midsummer blazing sun or the like compared to the inside of a house, and the use of the biodegradable disc inferior in heat resistance to the normal disc in an automobile is presumably not practical. Thus, when a loaded disc is a biodegradable disc, the disc is immediately ejected and the use is not accepted as in Embodiment 4, thereby obviating adverse effects on the disc 1 or the apparatus.

### Embodiment 4

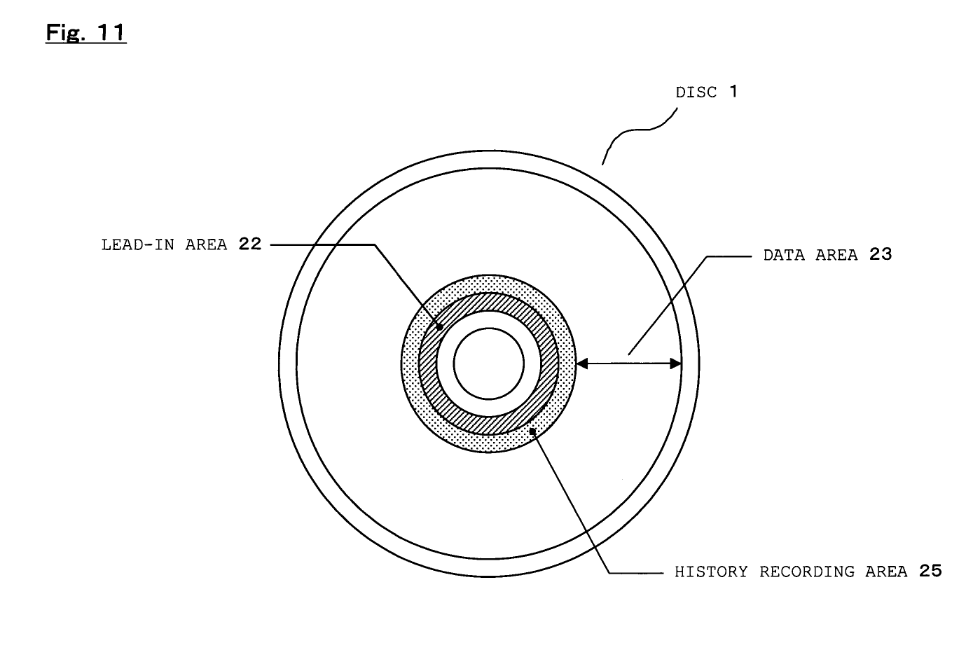

FIG. 11 is a diagram showing an area format of a biodegradable disc in Embodiment 4. As shown in FIG. 11, the biodegradable disc of Embodiment 4 is provided with a history recording area 25 on an outer diameter portion of the lead-in area 22. A CD-type biodegradable disc is provided with an optically-recordable track of spiral groove as the history recording area 25 on an outer diameter portion of the lead-in area. Further, a CD-R/RW-type biodegradable disc is provided with several tracks as the history recording area 25 on an outer diameter portion of the lead-in area. The identification information indicating a biodegradable disc is recorded on a part of the management area as in the above embodiments.

The history recording area 25 is an area for recording the number of times a temperature inside the optical recording apparatus is detected to be at a predetermined temperature or more during recording/reproducing on the optical disc 1 (biodegradable disc) The predetermined temperature as used herein refers to a temperature (50° C., for example) lower than the temperature (55° C., for example) for ejecting the optical disc 1.

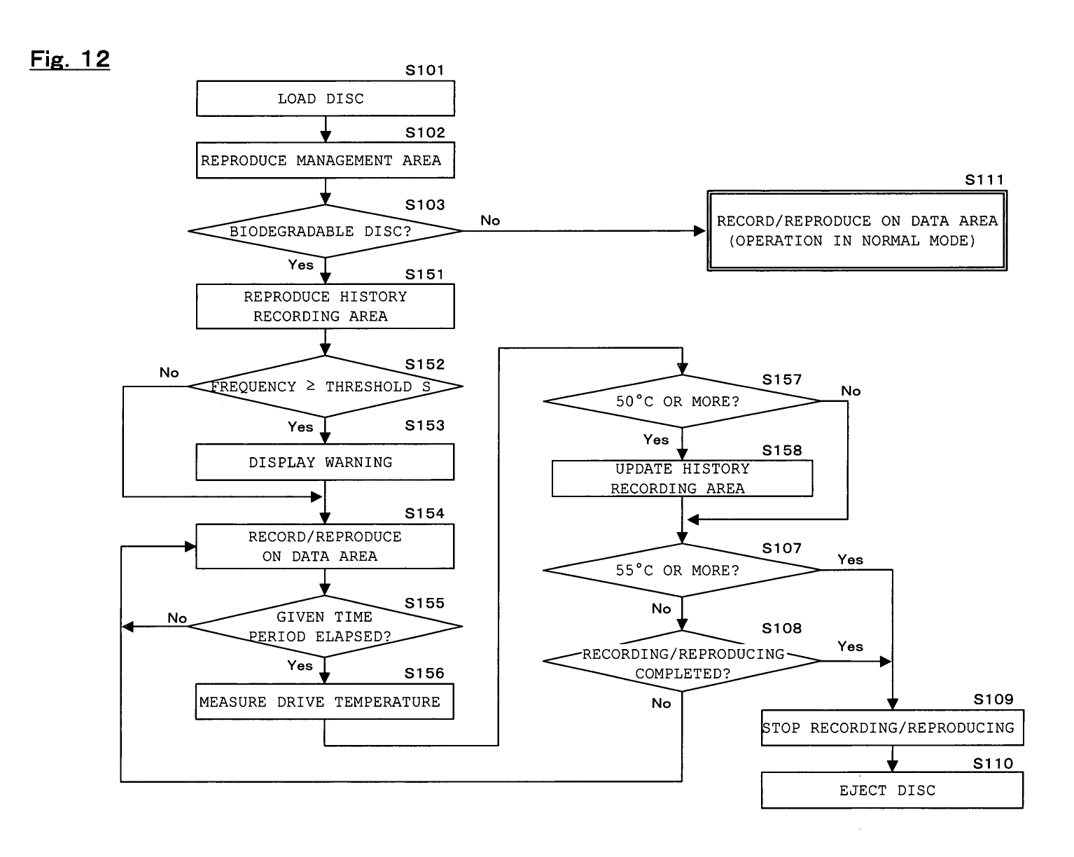

FIG. 12 shows a process flow in Embodiment 4. Of the steps in the flow chart, the steps which are the same as those of the flowchart in FIG. 7 of Embodiment 1 are denoted by the same symbols.

The disc 1 is loaded into the optical disc apparatus (step S101), and the management area 21 is read by the optical pick-up 104 (step S102). In subsequent step S103, the controller 113 determines whether or not the identification information indicating a biodegradable disc is recorded on the management area. When the identification information is recorded, the controller 113 judges that the loaded disc is a biodegradable disc and the process proceeds to step S151.

In step S151, the history recording area 25 is reproduced and the number of times (frequency) which the loaded optical disc (biodegradable disc) 1 had been exposed to a high temperature environment in the past can be checked. When the frequency is judged to be a predetermined number or more in step S152, a warning is displayed on the display unit 33 (step S153). Here, the threshold temperature for counting the number of times of the exposure to a high temperature environment is set to 50° C. as shown in the following step S157.

Then in step S154, recording/reproducing is carried out on the data area 23 of the optical disc 1. During recording/reproducing, a temperature inside the optical disc apparatus is periodically measured in steps S155 and S156. When a temperature inside the apparatus is judged to be at 50° C. or more instep S157, and a frequency value recorded in the history recording area 25 is updated in step S158. That is, information that the optical disc 1 is exposed to a high temperature environment is recorded on the history recording area 25 such that the frequency increases by one.

Further, when a temperature inside the apparatus of 55° C. or more, the controller 113 stops recording/reproducing on the optical disc 1 in step S109, and ejects the optical disc 1 to outside of the apparatus in step S110.

As described above, the history recording area 25 is provided on the outer diameter portion of the lead-in area 22 to record the history information. The history information may be recorded on a CD-RW to be included in a data-free area of the subcode information recorded on the lead-in area 22.

### Embodiment 5

A biodegradable disc in Embodiment 5 is provided with a thermochromic layer consisting of a material drastically changing in optical characteristics such as a refractive index at a predetermined temperature on a laser beam incidence surface side of the substrate 11.

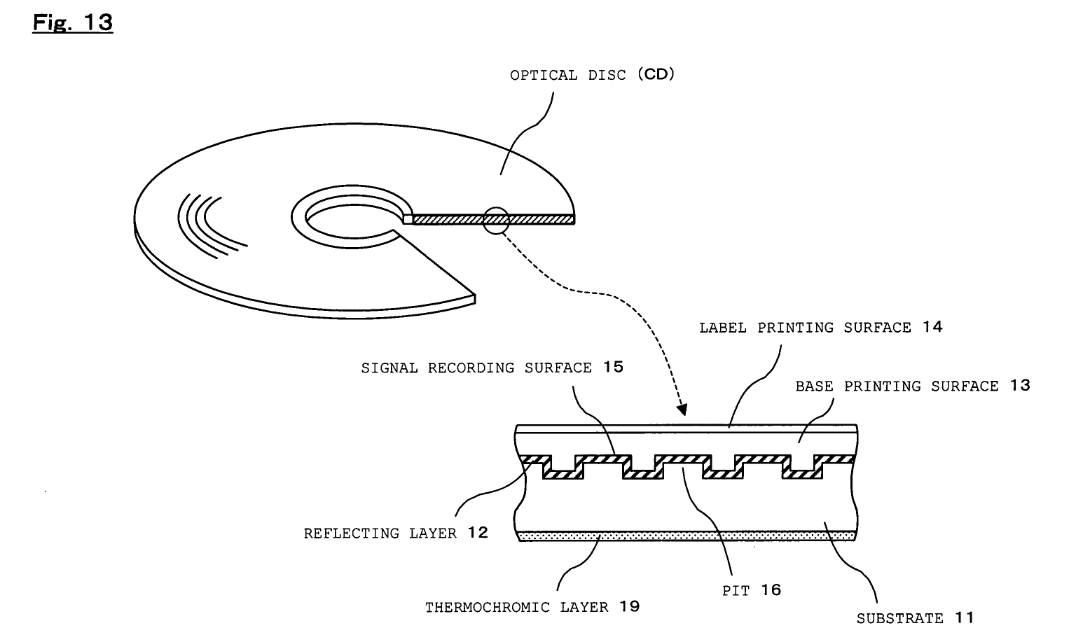

FIG. 13 shows a structure of a biodegradable disc according to Embodiment 5. FIG. 13 shows a structure of a CD-type biodegradable disc. Note that a CD-R/RW-type biodegradable disc is provided with a thermochromic layer 19 formed on a laser beam incidence surface side of the substrate 11 in the structure shown in FIG. 2. In the biodegradable disc, unlike the discs in the above embodiments, the identification information indicating a biodegradable disc need not be recorded on a part of the management area. In this case, the loaded disc is identified as a biodegradable disc based on a change in optical characteristics of the thermochromic layer 19.

The thermochromic layer 19 in Embodiment 5 changes in transmittance and reflectance characteristics when a temperature inside the apparatus approaches 60° C., which is a glass transition temperature of the substrate 11. An example of a material for the thermochromic layer 19 includes vanadium oxide, which changes in transmittance in an infrared wavelength region (laser wavelength used for CD) at 60° C. to 80° C.

Formation of the thermochromic layer 19 having such characteristics results in a drastic change in intensity of reflected light from the signal recording surface 15 when a temperature inside the apparatus approaches 60° C., which is a glass transition temperature of the substrate 11. A change in reflectance of the disc can be detected by the laser beam used for recording/reproducing.

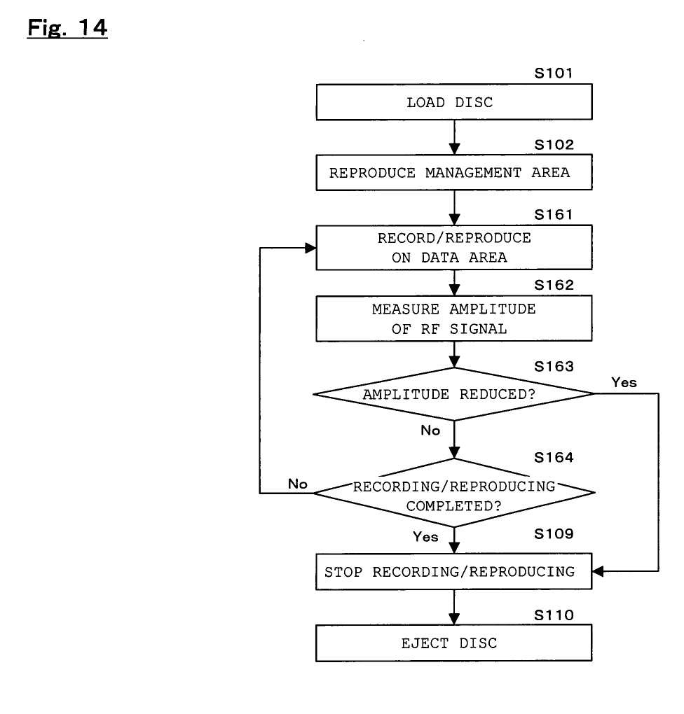

FIG. 14 is a diagram showing an operational flow of the optical disc apparatus in Embodiment 5. In the flowchart, a drastic change in amplitude of the reproduced signals compared to that immediately after start of the recording/reproducing operation on the data area 23 indicates that a transmittance of the thermochromic layer 9 has been reduced with increasing temperature inside the apparatus. The disc format is the same as that in Embodiment 1 (FIG. 4). Of the steps in the flow chart, the steps which are the same as those of the flowchart in FIG. 7 of Embodiment 1 are denoted by the same symbols.

The disc 1 is loaded into the optical disc apparatus (step S101), and the management area 21 is read by the optical pick-up 104 (step S102). Then, recording/reproducing is carried out on the data area 23 in step S161. In step S162, an amplitude of the reproduced signals obtained from the data area 23 is measured, and the measured amplitude is compared to the amplitude of the reproduced signals immediately after the start of the recording/reproducing on the data area 23 (step S163). When the present amplitude is drastically reduced compared to the amplitude of the reproduced signals immediately after the start of the recording/reproducing, a temperature inside the apparatus is judged to have increased. The controller 113 stops recording/reproducing on the optical disc 1 in step S109, and ejects the optical disc 1 to outside of the apparatus in step S110.

When the present amplitude is judged in step S163 to be reduced to only a small extent compared to the amplitude of the reproduced signals immediately after the start of the recording/reproducing, the controller 113 judges that the temperature inside the apparatus is increased to only a small extent and the operation proceeds to step S164. If the recording/reproducing operation is completed, the process proceeds to step S109, and if the recording/reproducing operation is not completed, the process returns to step S161.

The optical disc (biodegradable disc) 1 shown in FIG. 13 is provided with the thermochromic layer 19 on a laser beam incidence surface side of the substrate 11, but the thermochromic layer 19 may be provided between the substrate 11 and the reflecting layer 12 instead. Thus, a lamination process becomes easier than when the thermochromic layer 19 is provided on the laser beam incidence surface side of the substrate 11. When the thermochromic layer 19 is provided between the substrate 11 and the reflecting layer 12, a temperature of the thermochromic layer 19 at a laser beam emission position is much higher than an environment temperature inside the apparatus. Thus, a temperature at laser beam convergence position in the reflecting layer 12 is measured in advance when the environment temperature inside the apparatus reaches 60° C., which is a glass transition temperature of the substrate 11. A material for the thermochromic layer 19 is thus selected accordingly based on the measured temperature.

### Embodiment 6

In Embodiment 6, whether or not the optical disc is a biodegradable disc is determined during loading of the optical disc. If the optical disc is a biodegradable disc, use of the biodegradable disc is not accepted.

The biodegradable disc in Embodiment 6 has a structure with an inner diameter portion different from that of a normal disc. An optical disc apparatus detects such a difference in structure during disc loading. A biodegradable disc loaded is immediately ejected to outside of the apparatus.

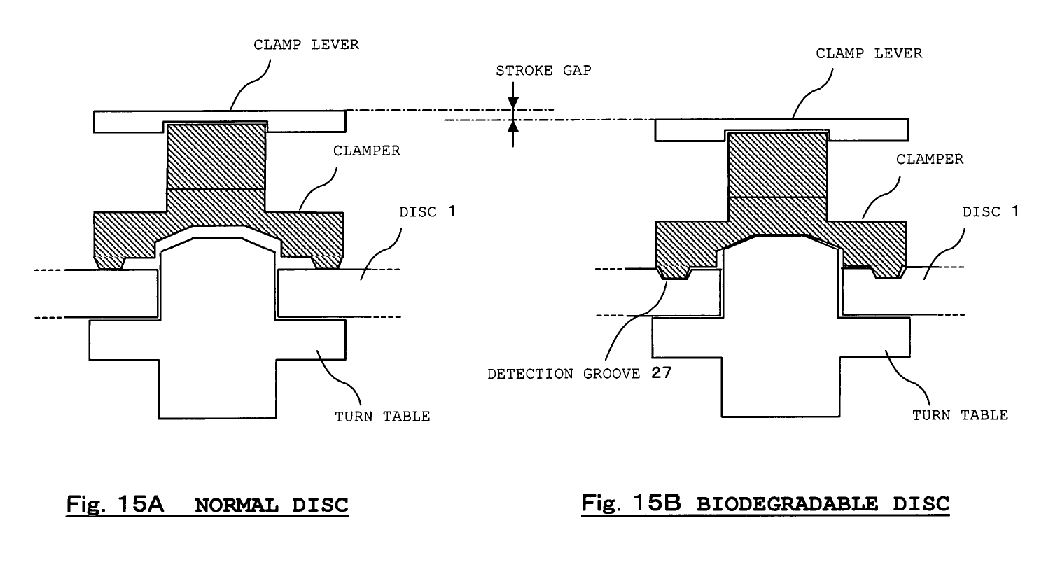

FIGS. 15A and 15B each show an example of structures of the disc and the optical disc apparatus in Embodiment 6. As shown in FIG. 15B, one side of the biodegradable disc is provided with a concentric detection groove 27 (depth of about 0.5 mm, width of about several mm) in a portion at a given distance away from an inner peripheral edge portion (clamp area 21 shown in FIG. 4). On the other hand, a damper of the optical disc apparatus has a concentric convex portion which fits into the concentric groove.

When a biodegradable optical disc is loaded into the optical disc apparatus, a convex portion of the clamper fits in to the detection groove 27 in an inner periphery portion of the biodegradable disc as shown in FIG. 15B. In contrast, when a normal disc is loaded into the optical disc apparatus, the convex portion of the damper does not fit into the detection groove 27 and holds down on a top surface of the disc 1 as shown in FIG. 15A. Thus, when the biodegradable optical disc is loaded into the optical disc apparatus, a position of the damper is lower by a depth of the detection groove 27 compared to when the normal disc is loaded. A difference in the position of the damper is reflected on a stroke gap of a clamp lever supporting the clamper. Thus, the stroke gap can be detected by a detection switch or the like, to determine whether or not the loaded disc is a biodegradable disc.

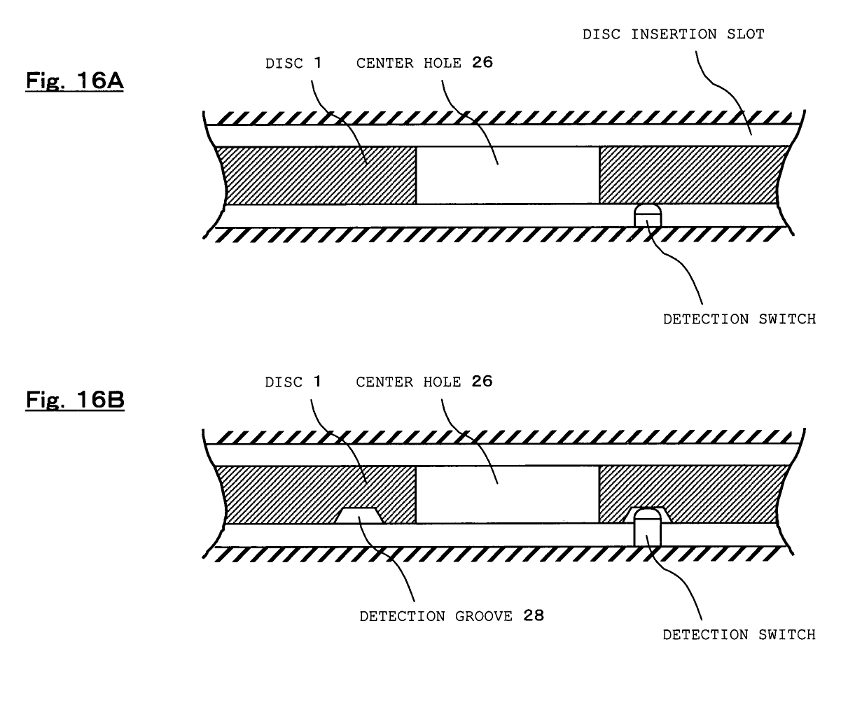

FIGS. 16A and 16B are diagrams each showing another example of the structures in Embodiment 6. The example of the structures is applied to a slot loading-type optical disc apparatus in which a disc is loaded through a disc insertion slot. The biodegradable disc is provided with the concentric groove 27 similar to the above formed on one side thereof. A detection switch is provided inside the disc insertion slot of the optical disc apparatus at a position fitting into concentric groove.

When a biodegradable optical disc is loaded into the optical disc apparatus, a detection switch fits into the detection groove 27 in an inner periphery portion of the biodegradable disc as shown in FIG. 16B. In contrast, when a normal disc is loaded into the optical disc apparatus, the detection switch does not fit into the detection groove 27 and touches a bottom surface of the disc 1. Thus, when the biodegradable disc is loaded in the optical disc apparatus, the detection switch turns ON by being pressed by the bottom surface of the disc, turns OFF by fitting into the detection groove 27, and turns ON by leaving from the detection groove 27. Whether or not the loaded disc is a biodegradable disc can be determined by detecting a state of the switch.

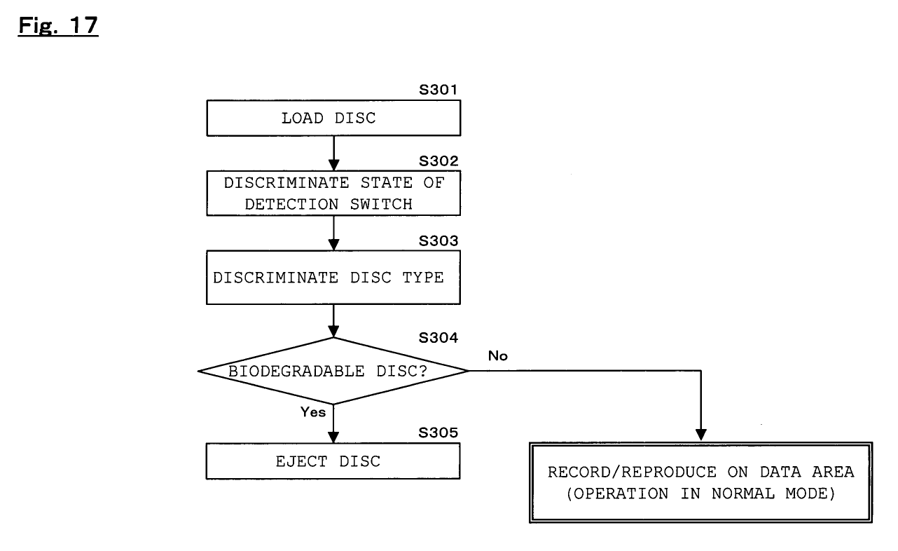

FIG. 17 shows an operational flow of the optical disc apparatus in Embodiment 6.

Disc loading is carried out in step S301. A state of the detection switch is then determined in step S302, and whether the loaded disc is a biodegradable disc or a normal disc is determined in step S303. When the disc is determined to be a biodegradable disc in step S304, the disc is immediately ejected, prohibiting use of the disc. On the other hand, when the disc is a normal disc, recording/reproducing is carried out on the data area in a normal mode.

The optical disc apparatus in Embodiment 6 is useful for a car audio optical disc apparatus which is often used in an environment at high temperatures such as in an automobiles as in Embodiment 3. When a temperature inside an automobile is high, a temperature inside the apparatus may be high even if an optical disc apparatus is not used. In this case, an optical disc of a biodegradable material having low heat resistance may be damaged just by loading the optical disc into the optical disc apparatus at high temperatures. Embodiment 6 prohibits not only the use of the optical disc of a biodegradable material, but also the loading of the disc into the apparatus. Thus, the disc can be thoroughly protected.

The biodegradable disc is distinguished from the normal disc by providing a characteristic structure to an inner diameter portion of the disc. However, when the disc is loaded into the optical disc apparatus in a state incorporated in a cartridge, a characteristic structure is provided on the cartridge such as providing a detection hole and such a structure may be detected by the optical disc apparatus.

### Embodiment 7

In Embodiment 7, a biodegradable disc is provided with an area changing in color when the disc reaches a specific temperature. The area may be provided by attaching onto a disc surface, an irreversible temperature detection sticker of which a temperature indication portion changes-in color at a specific temperature. An example of such a temperature detection sticker that can be used includes a “thermo label” (tradename).

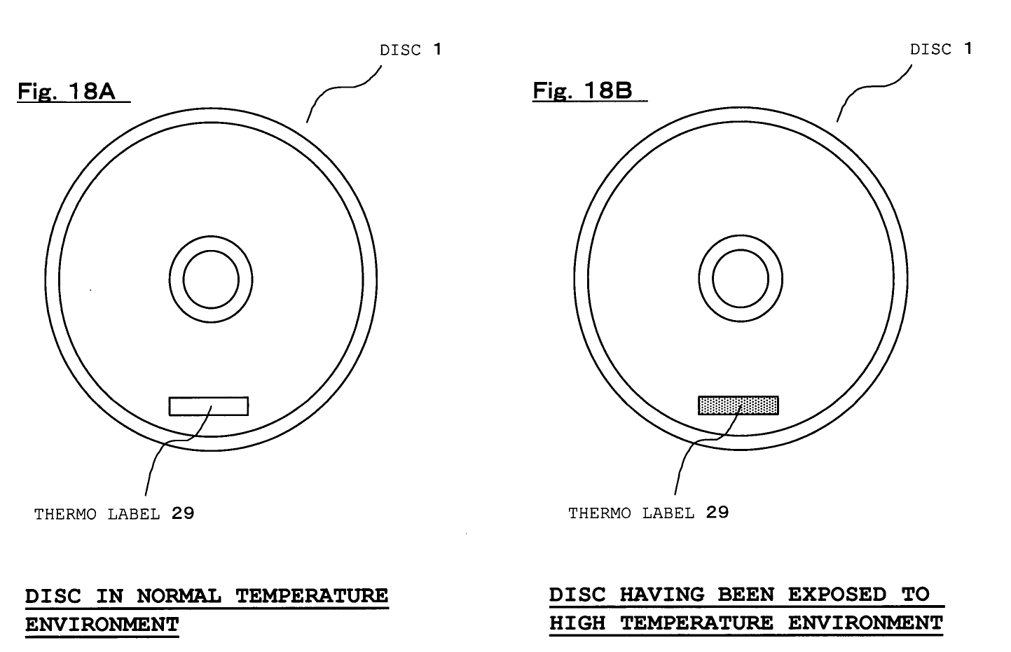

FIGS. 18A and 18B each show a structure of the optical disc (biodegradable disc) 1 in Embodiment 7. A thermo label 29 is attached onto a surface of the biodegradable disc on a side of the label printing layer 14. A temperature indication portion of the thermo label 29 contains: a color former called a leuco dye; and a developer consisting of bisphenol. Thus, the temperature indication portion changes in color at a specific temperature.

In Embodiment 7, the thermo label 29 changes from white to red at 60° C., which is a glass transition temperature of the substrate 11. A user can recognize whether or not the biodegradable disc is damaged from exposure to a high temperature environment through visual observation. Thus, the loading of the heat-damaged biodegradable disc into the optical disc apparatus can be obviated.

In Embodiment 7, the thermo label 29 is attached onto the disc surface, but a paint material consisting of the above color former or developer may be applied to the disk surface on a side of the label printing layer 14.

### Embodiment 8

In Embodiment 8, a coloring matter is included in the substrate 11 to provide a biodegradable disc having a substrate of a different color from that of the normal disc consisting of polycarbonate, so that a user can easily visualize that disc is a biodegradable disc. A natural coloring matter is preferably used as a coloring matter. Examples of the coloring matter include: chlorophyll or the like for a green substrate; sweet potato carotene, monascus color, turmeric color, or the like for a yellow substrate; safflower color, beet red color, lac color, red cabbage color, or the like for a red substrate; and caramel color or like for a brown substrate.

A synthetic coloring matter as a coloring matter only needs to be biodegradale. A substrate may be colored using a gravure ink or a coating agent employing a biodegradable resin such as “BIOTECH COLOR” (a tradename of Dainichiseika Color & Chemicals Mfg. Co., Ltd.), for example. Biodegradation takes place at a contact surface with microbes, and thus biodegradability differs by thickness. The gravure ink or the coating agent has a thickness of about several microns, and an ink layer or a coat layer degrades in about several months.

### Embodiment 9

In Embodiment 9, a disc is indicated as a biodegradable disc by printing a character string or a bar code on a surface of the disc on a side of the label printing layer 14 (hereinafter, referred to as “label printing surface”).

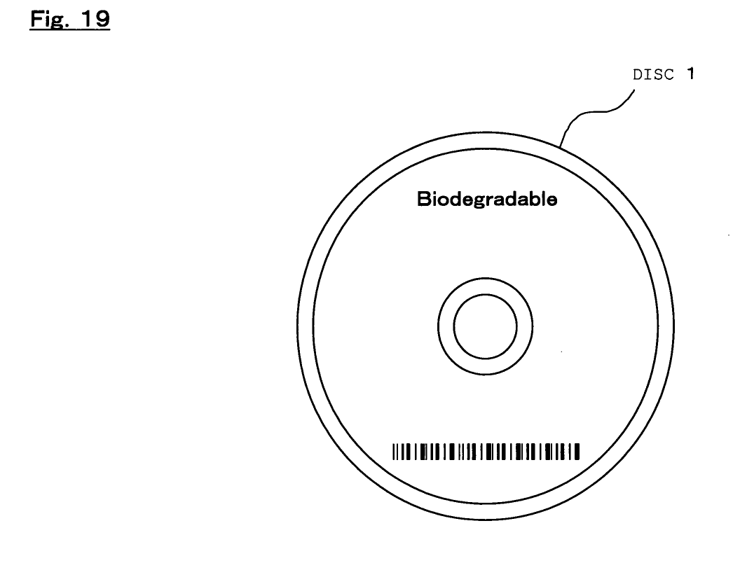

FIG. 19 is a diagram showing an example of a printing mode on a label printing surface of a biodegradable disc. In FIG. 19, characters of “Biodegradable” as a character string indicating that the disc is a biodegradable disc are printed on the label printing surface. Thus, a user can easily recognize that the disc is a biodegradable disc.

In addition, a bar code indicating information such as type of the substrate 11 (xx resin available from oo inc., for example) and type of microbes degrading the substrate 11. The microbes can be classified into aerobic microbes which cannot activate without oxygen and anaerobic microbes which can activate only in the absence of air. Thus, when the waste to be disposed is degraded by aerobic microbes, the waste is preferably disposed through landfill in the soil or the like. Further, when the waste to be disposed is degraded by anaerobic microbes, the waste is preferably disposed by storing in an air-tight a sealed environment or the like. Thus, whether the disc should be disposed through landfill or by storing in a sealed environment can be easily decided by reading a bar code printed in which the type of microbes degrading the substrate 11 is recorded.

The information relating to type of microbes degrading the substrate 11 or the like may be stored in the disc through a method other than bar code printing. A part of the label printing surface may be provided with a magnetic portion, and the information may be magnetically recorded on the magnetic portion.

The embodiment mode of the present invention is described as above. However, the embodiment mode disclosed is an example in all terms and should not limit the present invention. The scope of the present invention is indicated by the scope of claims and not the embodiment mode, and all modifications within the scope of claims and equivalent explanations are intended to be included in the scope of the present invention.

In the above embodiment mode, the biodegradable disc is exemplified as a recording medium of a biodegradable material, but the present invention may be implemented as an optical card of a biodegradable material. Similarly in the above embodiment mode, the optical disc apparatus for recording/reproducing on the biodegradable disc is exemplified, but the present invention may be materialized as an optical card apparatus for recording/reproducing on an optical card of a biodegradable material.

Further in the above embodiment mode, the present invention is mainly applied to a CD or CD-R/RW of a biodegradable material, but the present invention may be applied to an MO, MD, or DVD, and further to a next-generation DVD for recording/reproducing with a blue-violet laser beam.

Further in the above embodiment mode, a tray loading-type optical disc apparatus and a slot loading-type optical disc apparatus were exemplified as the optical disc apparatus, but an optical disc apparatus which loads or eject a disc through opening or closing of a top can also be employed.

1. A recording medium, comprising:
a substrate formed of a biodegradable material; and
a structure for identifying that the substrate is formed of the biodegradable material.

2. A recording medium according to claim 1, wherein information indicating that the substrate is formed of the biodegradable material is stored in a readable configuration.

3. A recording medium according to claim 1 or 2, wherein information indicating the number of times the recording medium is exposed to an environment at a predetermined temperature or more is stored in a readable configuration.

4. A recording medium according to claim 1, wherein:
the recording medium comprises an optical recording medium including a recording layer irradiated with a laser beam through the substrate; and
an area changing in optical characteristics at a predetermined temperature is provided on a path of the laser beam in the recording medium.

5. A recording medium according to claim 4, wherein the area is provided by forming a layer having a drastically reduced transmittance of the laser beam at a predetermined temperature, on a surface of the substrate on a laser beam incidence side.

6. A recording medium according to claim 1, wherein the area changing in color at a predetermined temperature is provided on an external surface of the recording medium.

7. A recording medium according to claim 6, wherein the area is provided by one of: attaching onto the external surface of the recording medium, an irreversible temperature detection sticker changing in color at the predetermined temperature; and applying a paint changing in color at the predetermined temperature, to the external surface of the recording medium.

8. A recording/reproducing apparatus for recording/reproducing on a recording medium, comprising:
detection means for detecting that a substrate of the recording medium is formed of a biodegradable material;
temperature measurement means for measuring a temperature inside the recording/reproducing apparatus; and
control means for controlling an operation on the recording medium based on detection results of the detection means and measurement results of the measurement means.

9. A recording/reproducing apparatus according to claim 8, wherein the control means stops a recording/reproducing operation on the recording medium when the detection means detects that the substrate of the recording medium is formed of a biodegradable material, and a temperature measured by the temperature measurement means is at a predetermined threshold temperature or more.

10. A recording/reproducing apparatus according to claim 9, wherein the control means, after stopping the recording/reproducing operation on the recording medium, ejects the recording medium to outside of the recording/reproducing apparatus.

11. A recording/reproducing apparatus for recording/reproducing on a recording medium, comprising:
detection means for detecting that a substrate of the recording medium is formed of a biodegradable material; and
control means for controlling a loading operation of the recording medium, wherein
after the detection means detects that the substrate of the recording means is formed of a biodegradable material, the control means correspondingly ejects the recording medium to outside of the recording/reproducing apparatus.

12. A recording/reproducing apparatus for recording/reproducing on a recording medium, comprising:
detection means for detecting that a substrate of the recording medium is formed of a biodegradable material; and
control means for controlling a rotational speed of the recording medium, wherein
the control means sets a maximum rotational speed of the recording medium to a lower value than the maximum rotational speed of the recording medium including a substrate formed of a nonbiodegradable material, when the detection means detects that the substrate of the recording means is formed of a biodegradable material.
